(19) United States
(12) Patent Application Publication
(10) Pub. No.: US 2006/0119330 A1
(43) Pub. Date: Jun. 8, 2006

(54) Electric energy regulating device

(76) Inventor: Hui Ju Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/258,454

(22) Filed: Oct. 25, 2005

(30) Foreign Application Priority Data
Nov. 24, 2004 (TW) 093218888

(51) Int. Cl. G05F 1/10; H02J 7/00

(52) U.S. Cl. 323/234; 320/127

(57) ABSTRACT

An electric energy regulating device for coupling to a battery of a transportation device and for regulating electric energy, includes a circuit board having two conductors for coupling to two electrodes of the battery, one or more electrolyte capacitors and one or more porcelain capacitors coupled between the conductors for receiving and supplying electric energy, or for absorbing impedance and inductance, and one or more EPROMs coupled between the conductors for controlling the circuit board to supply a stable electric energy to the electric facilities of the transportation device. One or more MEF capacitors may be coupled between the conductors for absorbing noises and electric shocks.

### BACKGROUND OF THE INVENTION

1. Field of the Invention

The present invention relates to an electric energy regulating device, and more particularly to an electric energy regulating device for attaching to or for coupling to various batteries, such as the batteries of various transportation means or vehicles, such as motorcycles, cars, pickups, cargos, boats, airplanes, trains, etc., and for compensating or regulating or controlling the electric energy for various electric facilities of the vehicles, and for increasing the working life of the batteries.

2. Description of the Prior Art

Typically, transportation means or vehicles, such as motorcycles, cars, pickups, cargos, boats, airplanes, trains, etc. may comprise one or more batteries disposed therein and coupled to various electric facilities of the vehicles, for supplying electric energy to energize and to actuate the electric facilities of the vehicles.

When the electric facilities of the vehicles are actuated or initialized, and/or when the engines of the vehicles are operated in different rotational speeds, such as idling or in high speed, the electric source or the electric energy or the electric voltage or current supplied from the batteries to the electric facilities may be changed.

For example, the electric energy may be supplied intermittently through the electric or inductor coils, the air conditioners may be operated intermittently, the electric energy supplied to the solenoid valves of the gear shifting devices may also be changed when the gear shifting devices are operated. The changing or altering of the electric energy or the electric voltage of the batteries may seriously decrease the working life of the batteries.

The present invention has arisen to mitigate and/or obviate the afore-described disadvantages of the conventional batteries for vehicles.

### SUMMARY OF THE INVENTION

The primary objective of the present invention is to provide an electric energy regulating device for attaching to or for coupling to various batteries, such as the batteries of various transportation means or vehicles, such as motorcycles, cars, pickups, cargos, boats, airplanes, trains, etc., and for compensating or regulating or controlling the electric energy for various electric facilities of the vehicles, and for increasing the working life of the batteries.

In accordance with one aspect of the invention, there is provided an electric energy regulating device for coupling to a battery of a transportation device, and for regulating electric energy, the electric energy regulating device comprising a circuit board including two conductors for coupling to two electrodes of the battery respectively, at least one first capacitor coupled between the conductors of the circuit board for receiving electric energy and for supplying the electric energy to electric facilities of the transportation device, at least one second capacitor coupled between the conductors of the circuit board for absorbing impedance and inductance, and at least one electrically programmable read only memory (EPROM) coupled between the conductors of the circuit board for controlling the circuit board to charge or discharge or release the electric energy, and to supply a stable electric energy to the electric facilities of the transportation device.

A housing may further be provided for receiving the circuit board, the housing includes an electric insulating layer disposed therein for shielding and protecting the circuit board, and for preventing the circuit board from being damaged. The housing may be selectively or optionally attached or coupled to the battery, and may include one or more electric insulating straps disposed in an inner peripheral portion thereof and/or an insert of non-saturated resin materials engaged in the inner peripheral portion thereof for further safely receiving and protecting the circuit board, and/or for cushioning the circuit board, and for further preventing the circuit board from being damaged.

The circuit board includes at least one third capacitor coupled between the conductors of the circuit board for absorbing such as electric noises and electric shocks that may be generated by the electric facilities of the transportation device. The third capacitor is preferably a metallized polyester film capacitors or metallized polypropylene film (MEF) capacitor which may be used to absorb or to reduce or to eliminate the electric noises and electric shocks of the electric facilities.

The circuit board includes a protective fuse coupled to one of the conductors of the circuit board for protecting and for preventing the battery from being shorted when the conductors are wrongly coupled to the electrodes of the batteries respectively, for example. The circuit board may further include a diode coupled between the conductors of the circuit board for further protecting the battery from being shorted. The diode may act independently, or may act in corporate with the fuse to protect the battery and to prevent the battery from being damaged or shorted or burned when the conductors are wrongly coupled to the electrodes of the battery respectively.

The circuit board includes a light emitting diode coupled between the conductors of the circuit board for indicating whether the circuit board is working or not. It is preferable that the first capacitor is an electrolyte capacitor, the second capacitor is preferably a porcelain capacitor. The EPROM is preferably arranged alternatively relative to the first capacitor and the second capacitor and/or the third capacitor.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an electric energy regulating device in accordance with the present invention, for attaching to a battery of a transportation means or vehicle;

FIG. 2 is a partial perspective view of the electric energy regulating device;

FIG. 3 is a plan schematic view illustrating an electric circuit of the electric energy regulating device;

FIG. 4 is a perspective view illustrating the other arrangement of the electric energy regulating device; and

FIG. 5 is an enlarged partial perspective view of the electric energy regulating device, illustrating the inner structure of the electric energy regulating device.

### DETAILED DESCRIPTION OF THE PREFERRED EMBODIMENT

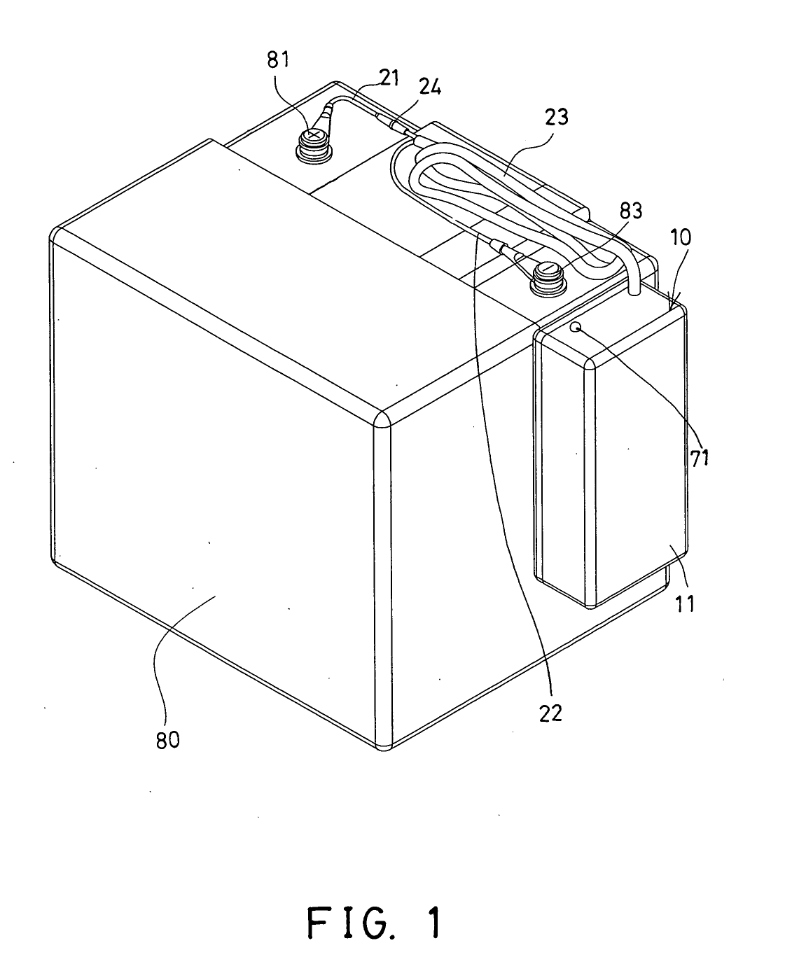

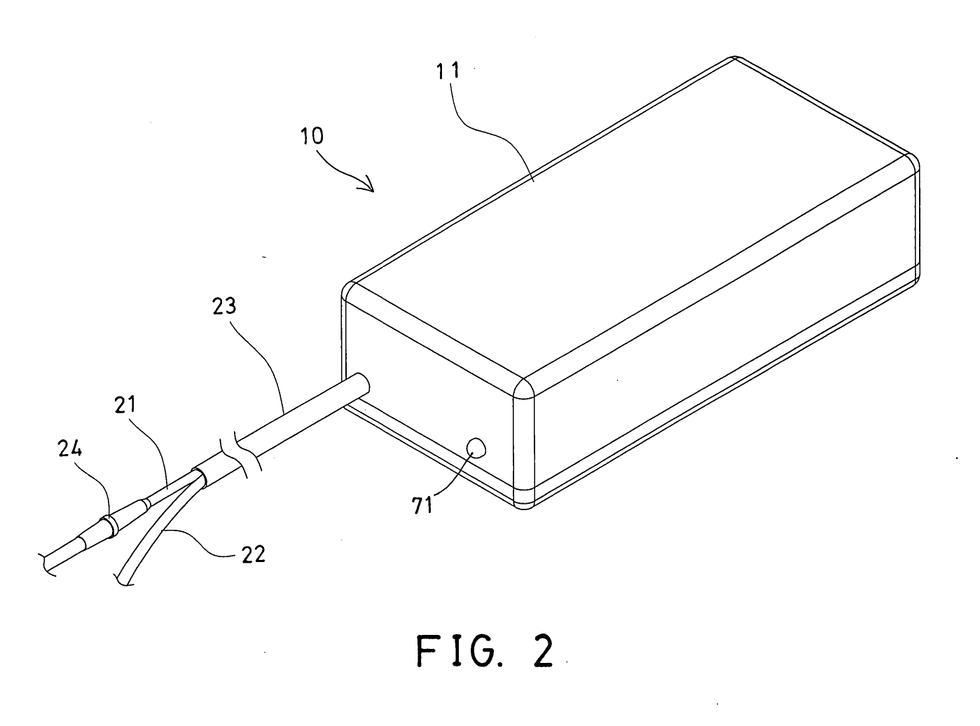

Referring to the drawings, and initially to FIGS. 1 and 2, an electric energy regulating device 10 in accordance with the present invention is designed or arranged for attaching to or for coupling to various batteries 80, such as the batteries 80 of various transportation means or vehicles, such as motorcycles, cars, pickups, cargos, boats, airplanes, trains, etc., and for compensating or regulating or controlling the electric energy for various electric facilities of the vehicles, and for increasing the working life of the batteries 80. The batteries 80 typically comprise two terminals or electrodes 81, 83, such as the positive and the negative electrodes 81, 83.

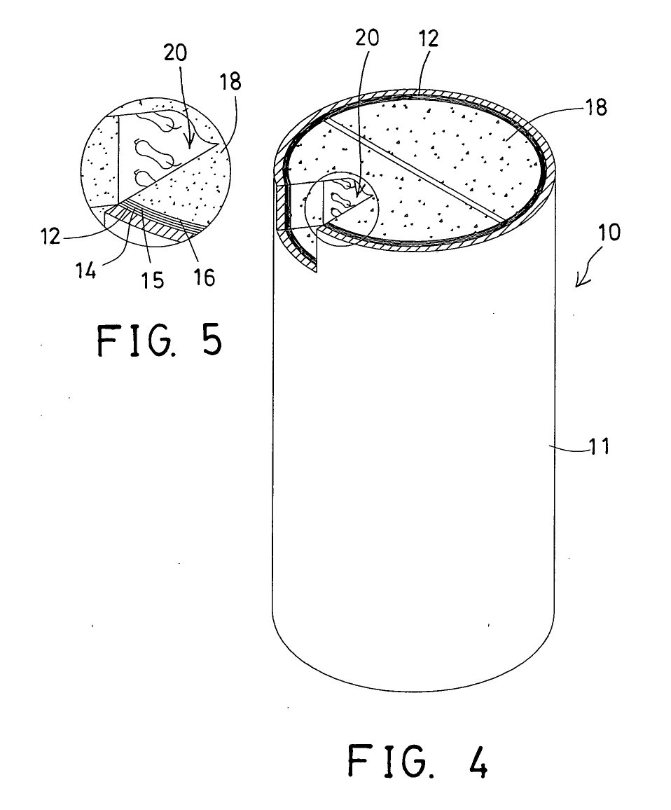

The electric energy regulating device 10 in accordance with the present invention comprises a housing 11 made or formed into various shapes or configurations, such as the parallelepiped structure as shown in FIGS. 1, 2, or the cylindrical shape as shown in FIG. 4, or the like. The housing 11 may be selectively attached onto the battery 80, as shown in FIG. 1. As shown in FIGS. 4 and 5, the housing 11 may include an electric insulating layer 12 and/or one or more electric insulating straps 14, 15, 16 attached to the inner peripheral portion thereof, and an insert 18 of such as non-saturated resin materials engaged therein, for safely receiving an electric circuit board 20 therein, and/or for shielding and protecting and/or cushioning the circuit board 20.

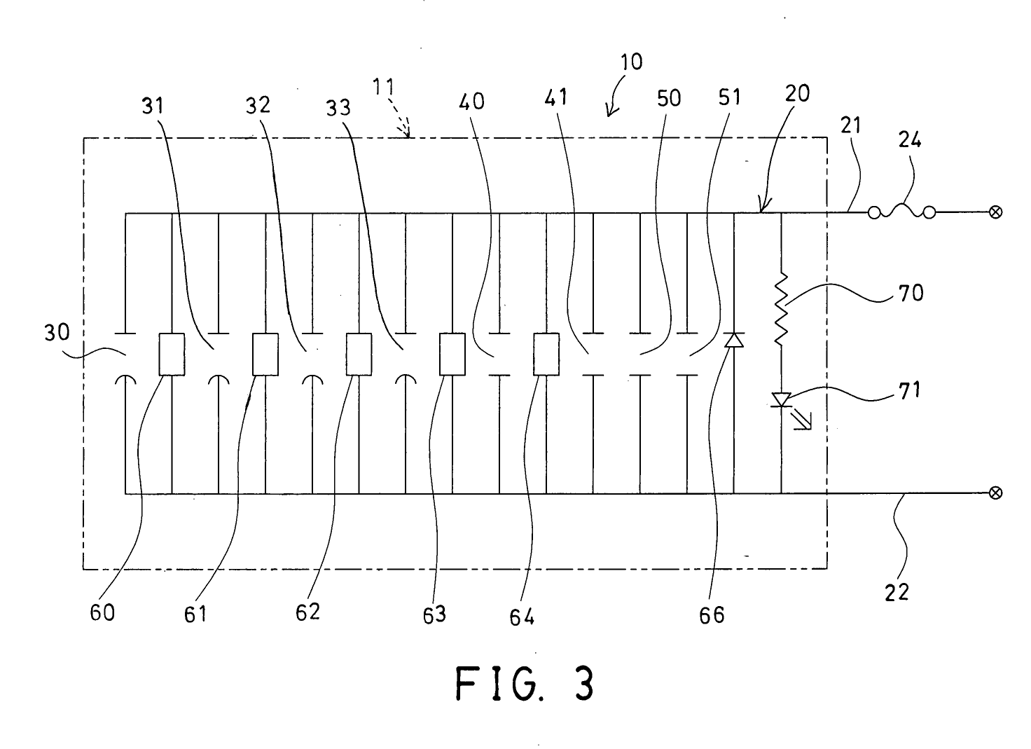

As shown in FIG. 3, the circuit board 20 includes two terminals or conductors 21, 22 preferably arranged in parallel to each other and extended out of the housing 11 (FIG. 2), for coupling to the electrodes 81, 83 of the batteries 80 respectively (FIG. 3). A protective and/or heat insulating sheath or outer covering 23 may further be provided and engaged onto the conductors 21, 22, for shielding and protecting the conductors 21, 22. It is preferable that a fuse 24 is coupled to one of the conductors 21, for protecting the battery 80 and for preventing the battery 80 from being damaged or shorted when the conductors 22, 21 are wrongly coupled to the electrodes 81, 83 of the batteries 80 respectively.

One or more, such as four first capacitors 30, 31, 32, 33, such as electrolyte capacitors 30-33 are coupled between the conductors 21, 22 of the circuit board 20, and arranged in parallel to each other, for receiving and/or absorbing or charging electric current from various electric facilities of the vehicles, and for supplying the charged electric energy to the other electric facilities that require a greater electric energy, for example. One or more, such as two further or second capacitors 40, 41, such as porcelain capacitors 40, 41 are also coupled between the conductors 21, 22 of the circuit board 20, and arranged in parallel to each other, for reducing and/or absorbing the high frequency impedance generated in the electrolyte capacitors 30-33, and/or for reducing and/or for eliminating the inductance generated in the ignition coils, for example.

One or more, such as two further or third capacitors 50, 51, such as metallized polyester film capacitors or metallized polypropylene film (MEF) capacitors 50, 51 are also coupled between the conductors 21, 22 of the circuit board 20, and also arranged in parallel to each other, for reducing and/or absorbing the high frequency noises and/or electric shocks generated in various electric facilities of the vehicles, for example. It is preferable that the second or porcelain capacitors 40, 41 are disposed or arranged beside the first or electrolyte capacitors 30-33, and the third or MEF capacitors 50, 51 are disposed beside the second or porcelain capacitors 40, 41 which are thus disposed between the electrolyte capacitors 30-33 and the MEF capacitors 50, 51.

One or more, such as five electrically programmable read only memories (EPROM) 60, 61, 62, 63, 64 may further be provided and also coupled between the conductors 21, 22 of the circuit board 20, and also arranged in parallel to each other, for coupling to the processor devices of the vehicles (not shown), and for monitoring and/or detecting and/or controlling the electric circuit of the vehicles, and/or for controlling the charging and/or the discharging and/or the releasing of the electric energy, in order to suitably supply the predetermined or required electric energy and/or voltage and/or current to various electric facilities of the vehicles. It is preferable that the EPROMs 60-64 are arranged alternatively relative to the first or electrolyte capacitors 30-33 and/or the second or porcelain capacitors 40, 41.

A diode 66 may further be provided and also coupled between the conductors 21, 22 of the circuit board 20, and arranged in parallel to the capacitors 30-33, 40-41, 50-51, and the EPROMs 60-64, and may act independently, or may act in corporate with the fuse 24, to protect the battery 80 and to prevent the battery 80 from being damaged or shorted or burned when the conductors 22, 21 are wrongly coupled to the electrodes 81, 83 of the batteries 80 respectively, for example. A resistor 70 and a light emitting diode (LED) 71 may further be provided and coupled in series with each other, but also coupled between the conductors 21, 22 of the circuit board 20, for generating an indicating light to indicate or to show whether the electric circuit board 20 is working or not.

In operation, the capacitors 30-33, 40-41, 50-51 may be provided for receiving and/or absorbing electric current or energy, and/or for supplying the electric energy to the other electric facilities, and/or for reducing or absorbing the high frequency impedance generated in the electrolyte capacitors 30-33, and/or for eliminating the inductance generated in the ignition coils, and/or for reducing or absorbing the high frequency noises or electric shocks generated in various electric facilities of the vehicles, such that the batteries 80 may be maintained in full load, and may provide or supply a stable electric current or energy to energize various electric facilities of the vehicles, particularly the ignition device of the vehicles.

The electric energy regulating device 10 may be attached to or coupled to various batteries 80, such as the batteries 80 from six (6) to twelve (12) volts, or the like, and/or the batteries 80 for various transportation means or vehicles, such as motorcycles, cars, pickups, cargos, boats, airplanes, trains, etc., which may include one or more cylinders therein. The fuse 24 and the diode 66 may be provided to form or to act as a safety device to protect the battery 80 and to prevent the battery 80 from being damaged or shorted or burned when the conductors 22, 21 are wrongly coupled to the electrodes 81, 83 of the batteries 80 respectively, for example.

Accordingly, the electric energy regulating device in accordance with the present invention may be provided for attaching or coupling to various batteries of various transportation means or vehicles, and for compensating or regulating or controlling the electric energy for various electric facilities of the vehicles, and for increasing the working life of the batteries.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electric energy regulating device for coupling to a battery of a transportation means, and for regulating electric energy, said electric energy regulating device comprising:
a circuit board including two conductors for coupling to two electrodes of the battery respectively,
at least one first capacitor coupled between said conductors of said circuit board for receiving electric energy and for supplying the electric energy to electric facilities of the transportation means,
at least one second capacitor coupled between said conductors of said circuit board for absorbing impedance and inductance, and
at least one EPROM coupled between said conductors of said circuit board for controlling said circuit board to charge or discharge or release the electric energy, and to supply a stable electric energy to the electric facilities of the transportation means.

2. The electric energy regulating device as claimed in claim 1 further comprising a housing for receiving said circuit board, said housing including an electric insulating layer disposed therein for protecting said circuit board.

3. The electric energy regulating device as claimed in claim 2, wherein said housing includes at least one electric insulating strap disposed in an inner peripheral portion thereof for safely receiving and protecting said circuit board.

4. The electric energy regulating device as claimed in claim 2, wherein said housing includes an insert of non-saturated resin materials engaged therein for safely receiving and protecting said circuit board.

5. The electric energy regulating device as claimed in claim 1, wherein said circuit board includes at least one third capacitor coupled between said conductors of said circuit board for absorbing noises and electric shocks.

6. The electric energy regulating device as claimed in claim 5, wherein said at least one third capacitor is an MEF capacitor.

7. The electric energy regulating device as claimed in claim 1, wherein said circuit board includes a fuse coupled to one of said conductors for protecting said battery from being shorted.

8. The electric energy regulating device as claimed in claim 1, wherein said circuit board includes a diode coupled between said conductors of said circuit board for protecting said battery from being shorted.

9. The electric energy regulating device as claimed in claim 1, wherein said circuit board includes a light emitting diode coupled between said conductors of said circuit board for indicating whether said circuit board is working or not.

10. The electric energy regulating device as claimed in claim 1, wherein said at least one first capacitor is an electrolyte capacitor.

11. The electric energy regulating device as claimed in claim 1, wherein said at least one second capacitor is a porcelain capacitor.

12. The electric energy regulating device as claimed in claim 1, wherein said at least one EPROM is arranged alternatively relative to said at least one first capacitor and said at least one second capacitor.
